(19) United States
(12) Patent Application Publication
(10) Pub. No.: US 2004/0076796 A1
(43) Pub. Date: Apr. 22, 2004

(54) Cornerboard protector including package stand-off feature

(76) Inventors: Dan Stubing, Neenah, WI (US); Norm Bell, Appleton, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/682,449

(22) Filed: Oct. 9, 2003

Related U.S. Application Data
(60) Provisional application No. 60/417,488, filed on Oct. 10, 2002.

(51) Int. Cl. B32B 7/00

(52) U.S. Cl. 428/119

(57) ABSTRACT

A product protector for use in creating a standoff height between the outer surfaces of a load being shipped and a shipping container. The product protector includes a pair of side legs joined with each other at a right angle to define a corner of the product protector. Each side leg includes a standoff leg integrally formed therewith. The standoff leg extends perpendicularly from the side leg and contacts the inner surface of one of the walls of the shipping container. The standoff leg provides the required spacing between the shipping container and the load being package. Preferably, the side leg and the standoff legs are integrally formed from paperboard material.

### CROSS-REFERENCE TO RELATED APPLICATIONS

This application is based on and claims priority from provisional U.S. patent application Serial Number 60/417,488 filed on Oct. 10, 2002.

### BACKGROUND OF THE INVENTION

The present invention relates to a package protector for use in shipping large articles. More specifically, the present invention relates to a package protector that provides a specified standoff distance between the faces of an article or load being shipped and the shipping container, such as a cardboard box.

Currently, shipping companies require product manufacturers to package products in a manner specified by the shipping company before the shipping company will insure the contents of a package against damage that may occur during the shipping process. One of the packaging specifications required by many shipping companies is a standoff distance between the shipping container and the actual product within the container. For example, many shipping companies require a standoff distance of between 1/2 inch and 3/4 inch between the face of a product being shipped and its cardboard shipping container. For example, if a refrigerator is being shipped in a cardboard package, the 3/4 inch gap must exist between each face of the refrigerator and the cardboard box.

Currently, many different packaging methods and apparatus are utilized to provide the desired standoff required by shipping companies. Most of these protectors require additional components other than a typical corner protector already installed upon the product being shipped. The additional product packaging increases the cost of the packaging and requires the manufacturer to inventory additional packaging pieces, which raises both the time and space required for packing a product in a shipping container.

Therefore, a need currently exists for a product protector that provides the required standoff distance between the product being shipped and the cardboard container without increasing the number of components and cost associated with packaging the product in a cardboard container. Further, a need exists for a product protector that can be cheaply manufactured and compliments currently available product packaging material.

### SUMMARY OF THE INVENTION

The present invention is a product protector for installation along the corners of a load to be shipped to create the required standoff from the sides of the load to walls of a shipping container. The product protector of the present invention includes a pair of side legs joined to each other at approximately a right angle to define a corner. The corner of the product protector is installed in contact with the corner of the product being shipped, as is conventional.

The product protector further includes a pair of standoff legs each extending at a right angle to one of the side legs. The standoff legs extend away from the side of the load to be protected and include an end portion that contacts the inner surface of the shipping container. Each standoff leg provides a required standoff height between the load and the shipping container.

In the preferred embodiment of the invention, the product protector is formed from a laminated paperboard structure. The product protector is formed having a continuous length and is cut to length depending upon the packaging requirements.

In a second embodiment of the invention, the product protector includes a curved, corner portion positioned between the pair of side legs. The curved, corner portion extends into the corner of the shipping container and provides the required standoff for two sides of the load being shipped. Once again, the second embodiment of the invention is formed from laminated paperboard structure and is shaped into its desired configuration and subsequently cut to the desired length.

Various other features, objects and advantages of the invention will be made apparent from the following description taken together with the drawings.

### BRIEF DESCRIPTION OF THE DRAWINGS

The drawings illustrate the best mode presently contemplated of carrying out the invention.

In the drawings:

FIG. 1 is a top view illustrating a product within a shipping container utilizing the product protector of the present invention;

FIG. 2 is a magnified view taken along line A-A of FIG. 1;

FIG. 3 is a perspective view of the first embodiment of the product protector of the present invention;

FIG. 4 is an end view of the first embodiment of the product protector of the present invention;

FIG. 5 is a side view of the first embodiment of the product protector of FIG. 3;

FIG. 6 is a top view illustrating a second embodiment of the product protector used to provide the required spacing between the load and the shipping container;

FIG. 7 is a magnified view taken along line 7-7 of FIG. 6; and

FIG. 8 is a perspective view of the second embodiment of the product protector of the present invention.

### DETAILED DESCRIPTION OF THE INVENTION

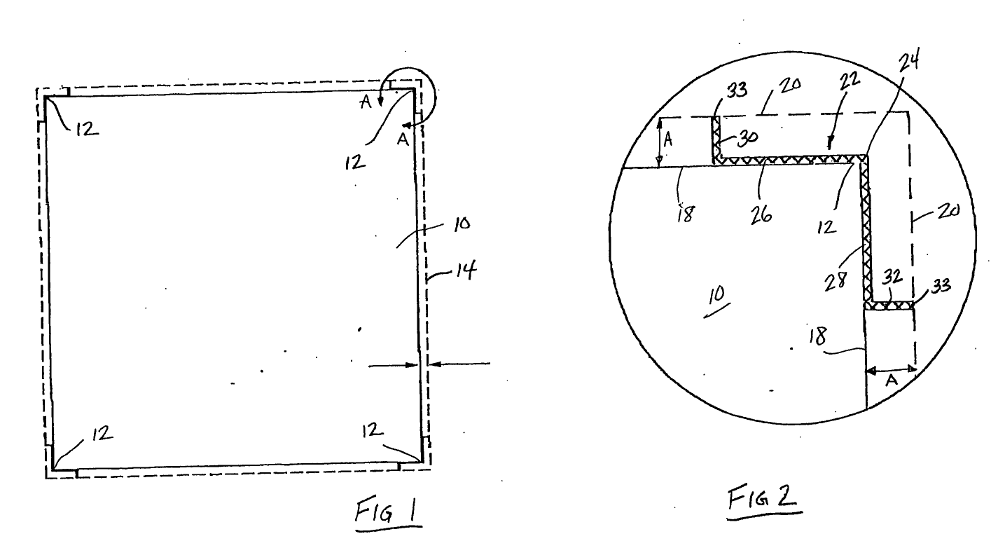

Referring first to FIG. 1, thereshown is the product or load 10 to be protected during the shipping process. In the embodiment of the invention illustrated in FIG. 1, the load 10 has a square configuration defined by four separate corners 12. However, the present invention is not limited to use with a square or rectangular load.

As illustrated in FIG. 1, the load 10 is contained within a shipping container 14. The container 14 generally corresponds in shape to the configuration of the load 10 and is constructed specifically for shipping the load 10. In the embodiment of the invention illustrated, the container 14 is made from corrugated cardboard, although other types of containers 14 could be used to enclose the load 10.

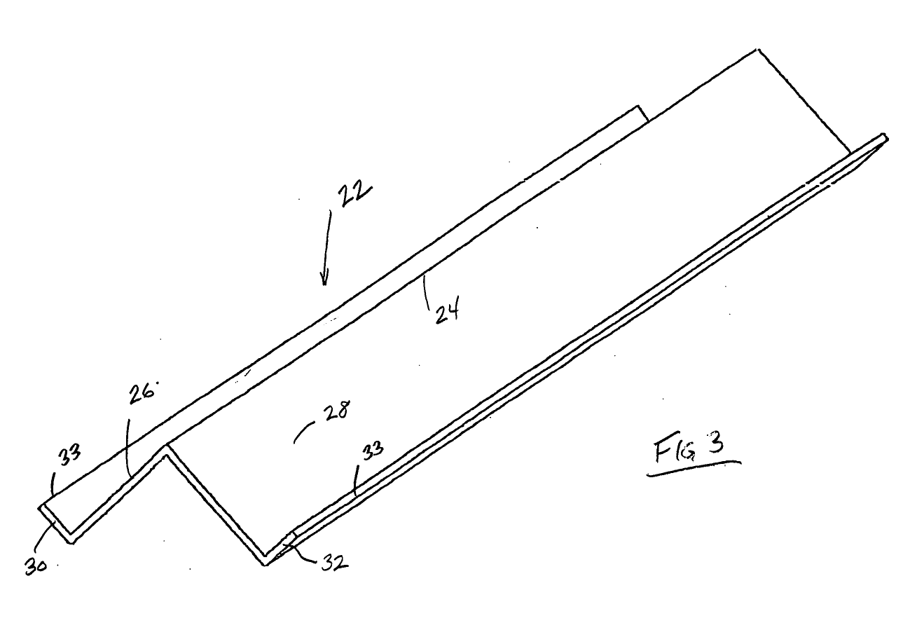

As best illustrated in FIG. 2, the sidewalls 18 of the load 10 are spaced from the sidewalls 20 of the container by a standoff height A. The standoff height A is provided to reduce the likelihood of damage to the load 10 during shipping. Typically, the standoff height is dictated by the company handling the shipping and is typically between ½ and 3/4 inch. In the embodiment of the invention illustrated, the standoff height is ¾ of an inch.

As illustrated in FIG. 2, a product protector 22 is installed along the corner 12 of the load 10. The product protector 22 defines a corner 24 and includes a pair of generally planar or flat side legs 26 and 28 positioned at a generally right angle relative to each other. Each of the side legs 26 and 28 is positioned in contact with the sidewalls 18 of the load 10 and protects the corner 12 of the load 10 against damage. A corner protector having only the pair of side legs 26 and 28 is conventional and has been known and used for many years.

As illustrated in FIG. 2, the product protector 22 of the present invention includes a pair of generally planar or flat standoff legs 30 and 32 formed on the side legs 26 and 28, respectively. The standoff legs 30 and 32 create the standoff height A between the shipping container and are integrally formed as part of the complete product protector 22. In the embodiment of the invention illustrated, each of the standoff legs 30 and 32 has a height of ¾ of an inch and extends at a right angle relative to the respective side leg 26 or 28 to provide the required standoff height A dictated by the shipping company.

As illustrated in FIG. 2, each of the standoff legs 26 and 28 includes an outer end 33 that contacts the inner surface of the sidewalls 20 of the shipping container. The outer end 33 provides for a positive point of contact between the product protector 22 and the shipping container to maintain the standoff height.

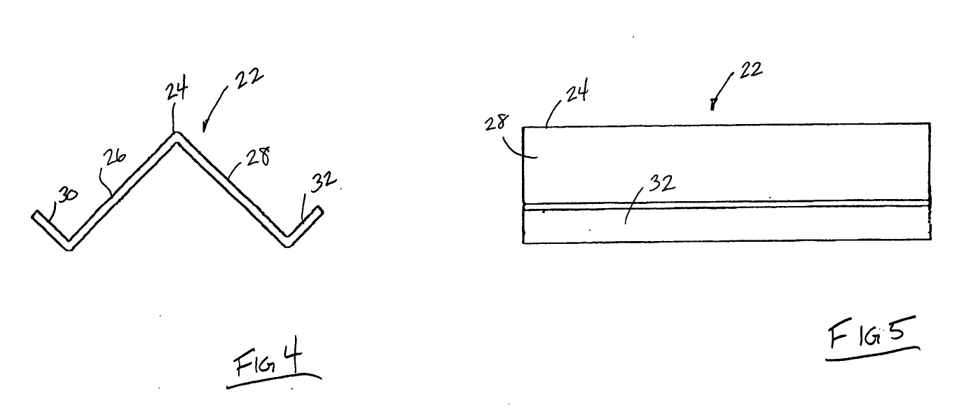

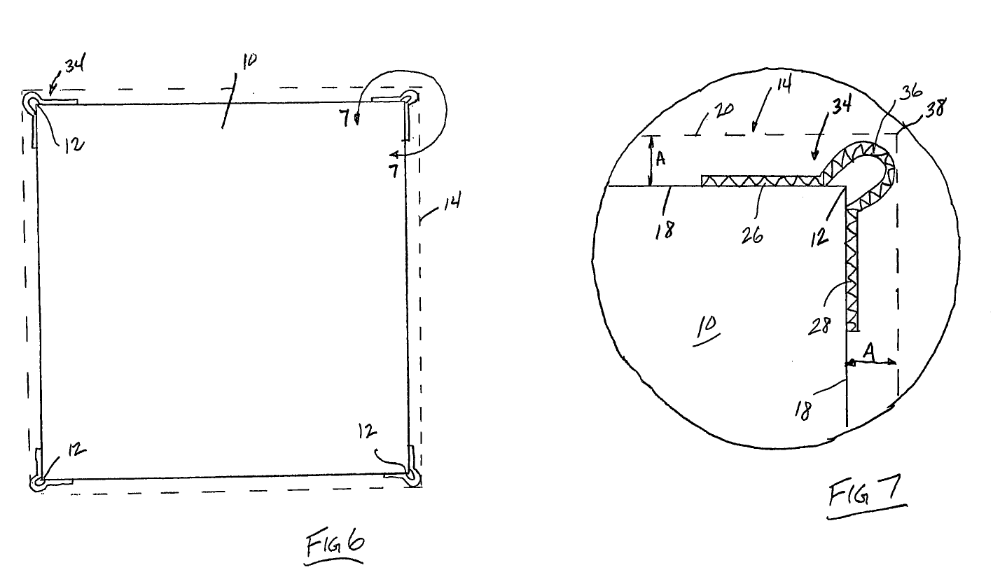

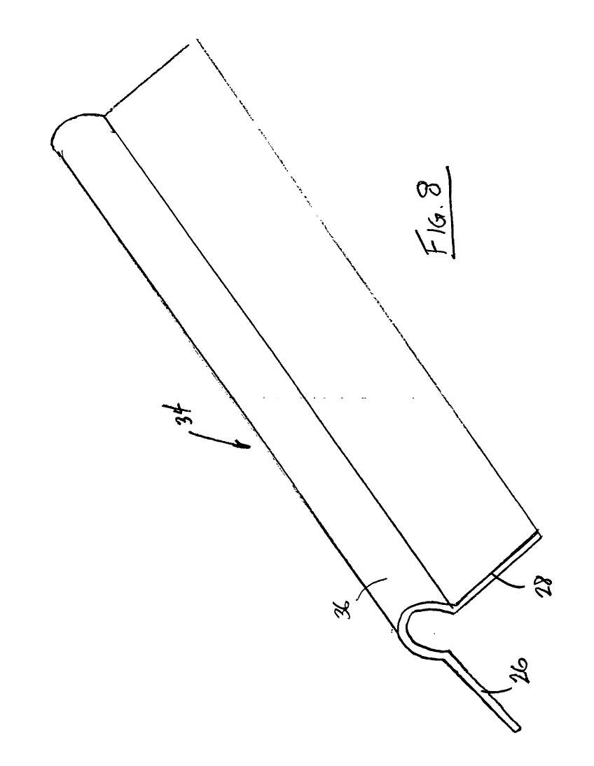

In the preferred embodiment of the invention, the product protector 22 is formed from laminated sheets of paperboard that are formed into the shape illustrated in FIGS. 3-5. When the laminated structure of paper is wet, the structure is bent into the shape illustrated to define the corner and the pair of standoff legs 30 and 32.

Once the product has been shaped into its desired form, the product is dried and the paper material forms a rigid structure having the shape illustrated. In the preferred embodiment of the invention, the product protector 22 is formed having a continuous length with a generally uniform thickness and is cut to size during the formation process. Although the product protector 22 of the present invention is shown and described as being formed form laminated paper, it is contemplated by the inventor that other substantially rigid materials, such as plastic or foam, could be utilized while following within the scope of the present invention.

Referring now to FIGS. 6 and 7, thereshown is a second embodiment of the product protector 34 of the present invention. In the second embodiment of the invention, the product protector 34 is again positioned around each corner 12 of the load 10 to provide the required spacing between the load and the shipping container. However, in the second embodiment, as illustrated in FIG. 7, the corner of the product protector 34 includes a rounded standoff portion 36 positioned between the pair of side legs 26 and 28. When the product protector 34 is installed along the edge of the corrugated container, the standoff portion 36 extends into the corner 38 of the shipping container 14 and provides the required standoff height from both of the faces of the shipping container.

As in the first embodiment of the invention, the product protector of the second embodiment of the invention is preferably formed from laminated sheets of paper material. The laminated sheets of paper material are shaped into the configuration illustrated and dried such that the product protector conforms to the shape illustrated. Once again, although the preferred embodiment of the invention is illustrated utilizing laminated paper, it is contemplated by the inventor that other materials could be used, such as plastic or foam, while operating within the scope of the present invention.

Various alternatives and embodiments are contemplated as being within the scope of the following claims particularly pointing out and distinctly claiming the subject matter regarded as the invention.

We claim:

1. A product protector for creating a standoff height when placed between a load being shipped and a shipping container, the product protector comprising:
a first side leg and a second side leg joined to each other to define a corner, each of the side legs being positioned in substantially continuous contact with a different face surface of the load being shipped;
a first standoff leg contained on the first side leg, the first standoff leg extending approximately 90° from the first side leg; and
a second standoff leg integrally formed with the second side leg, the second standoff leg extending at approximately 90° relative to the second side leg;
wherein the first and second standoff legs contact the shipping container to provide the standoff height between the shipping container and the product package.

2. The product protector of claim 1, wherein the product protector is formed from laminated paperboard material.

3. The product protector of claim 1, wherein the side legs and the standoff legs are integrally formed.

4. The product protector of claim 1, wherein the product protector is formed from a substantially rigid material.

5. The product protector of claim 1, wherein the side legs and the standoff legs have substantially uniform thickness.

6. The product protector of claim 1, wherein the length of the standoff legs is less than the length of the side legs.

7. The product protector of claim 1, wherein the side legs are joined together at substantially 90° relative to each other.

8. The product protector of claim 1, wherein the side legs and the standoff legs are flat.

9. A product protector for providing a standoff height between a load being shipped and the walls of a shipping container, the product protector comprising:
a first side leg and a second side leg positioned at approximately 90° relative to each other, each of the side legs being in substantially continuous contact with a different face surface of the load being shipped; and
a corner portion positioned between the first side leg and the second side leg, the corner portion having a arcuate shape, wherein the corner portion contacts a corner of the shipping container to define the standoff height between the walls of the shipping container and the load being shipped.
